(19) United States
(12) Patent Application Publication
(10) Pub. No.: US 2003/0030421 A1
(43) Pub. Date: Feb. 13, 2003

(54) Power supply unit

(76) Inventors: Christoph Loef, Aachen (DE); Thomas Duerbaum, Langerwehe (DE); Eberhard Waffenschmidt, Aachen (DE); Matthias Wendt, Wuerselen (DE); Heinz Van Der Broeck, Zuelpich (DE); Manfred Albach, Neunkirchen Am Brand (DE)

Correspondence Address: U.S. Philips Corporation, 580 White Plains Road, Tarrytown, NY, 10591, US

(21) Appl. No.: 10/213,577

(22) Filed: Aug. 7, 2002

(30) Foreign Application Priority Data
Aug. 10, 2001 (DE) 10139445.4

(51) Int. Cl. G05F 1/56

(52) U.S. Cl. 323/285

(57) ABSTRACT

The invention relates to a power supply unit for supplying power to a plasma display panel, wherein an active network filter without electrical isolation is provided for the generation of an essentially constant DC voltage from an AC supply voltage, a DC-DC voltage converter being connected to the output of the active network filter with at least one first and one second output and with electrical isolation between the constant DC voltage and the outputs, a regulator being assigned to the DC-DC voltage converter to regulate the voltage at the first output, and a voltage actuator being connected in series at least to the second output.

The invention relates to a power supply unit for supplying power to a plasma display panel.

Various demands are made on the power supply to plasma display panels, which, among other applications, are increasingly being used for television receivers. For one thing, the power consumption is approximately 100 W to 1000 W, depending on the size and the brightness emitted; for another, the loading on the power source is pulsating, while the DC voltages have to be constant. Moreover, the level of the respective DC voltages to be generated depends on the individual plasma display panel. Finally, apart from an electrical network isolation, the loading on the network should be as sinusoidal as possible.

It is an object of the invention to propose a power supply unit fulfilling these requirements for supplying power to a plasma display panel for which a plurality of supply voltages are required, which depend in different ways on the picture content and the brightness and contrast settings.

This object is achieved according to the invention by a power supply unit, wherein an active network filter without electrical isolation is provided for the generation of an essentially constant DC voltage from an AC supply voltage, a DC-DC voltage converter being connected to the output of the active network filter with at least one first and one second output and with electrical isolation between the constant DC voltage and the outputs, a regulator being assigned to the DC-DC voltage converter to regulate the voltage at the first output, and a voltage actuator being connected in series at least to the second output.

The invention preferably provides that the regulator regulates the voltage at the one output to an applied first reference voltage. This reference voltage may be generated in a circuit connected to the plasma display panel so that, on installation of the power supply unit according to the invention, the latter is automatically matched to the individual voltage requirement of the plasma display panel.

Apart from achieving the object according to the invention, the power supply unit has the further advantage of a high power efficiency which, on the one hand, directly assists energy saving and, on the other, owing to the lower power dissipation, brings about structural advantages which have positive effects on costs and service life.

A further embodiment of the invention provides that a voltage actuator is series-connected to at least the other output, while preferably the voltage actuator contains a further regulator to which a further reference voltage can be fed. An extensive decoupling of the outputs of the power supply unit is thereby achieved so that load fluctuations at the one output do not make themselves felt as voltage fluctuations at the other output. Here too, a presetting of this voltage is also possible in a circuit assigned to the plasma display panel.

The further embodiment specified above may be designed in such a way that the voltage actuator sets the entire power drawn from this output. The DC voltage can thereby be increased or reduced at the other output as required.

A solution that is more favorable in terms of power efficiency, however, consists in an embodiment such that the voltage actuator sets a power that is required for matching the voltage on the further output to the output voltage of the series-connected actuator. In this embodiment, the power dissipation is conditional only on the current and the error voltage, i.e. is related only to the differential power but with the same efficiency.

For the network isolation, provision is preferably made in the power supply unit according to the invention for the DC-DC voltage converter to be equipped with at least one transformer. It can operate with or without resonance.

Another embodiment of the power supply unit according to the invention enables a single voltage supply of a standby voltage in that the transformer is equipped with an additional winding which, together with a resonant capacitor, forms a resonant circuit with a resonant frequency which is above the operating frequency of the DC-DC voltage converter, and in that the voltage can be drawn from the resonant capacitor via a rectifier to supply a standby operation, and in that a device is provided to increase the operating frequency to the resonant frequency of the resonant circuit when standby operation is to take place.

The invention will be further described with reference to examples of embodiment shown in the drawings to which, however, the invention is not restricted:

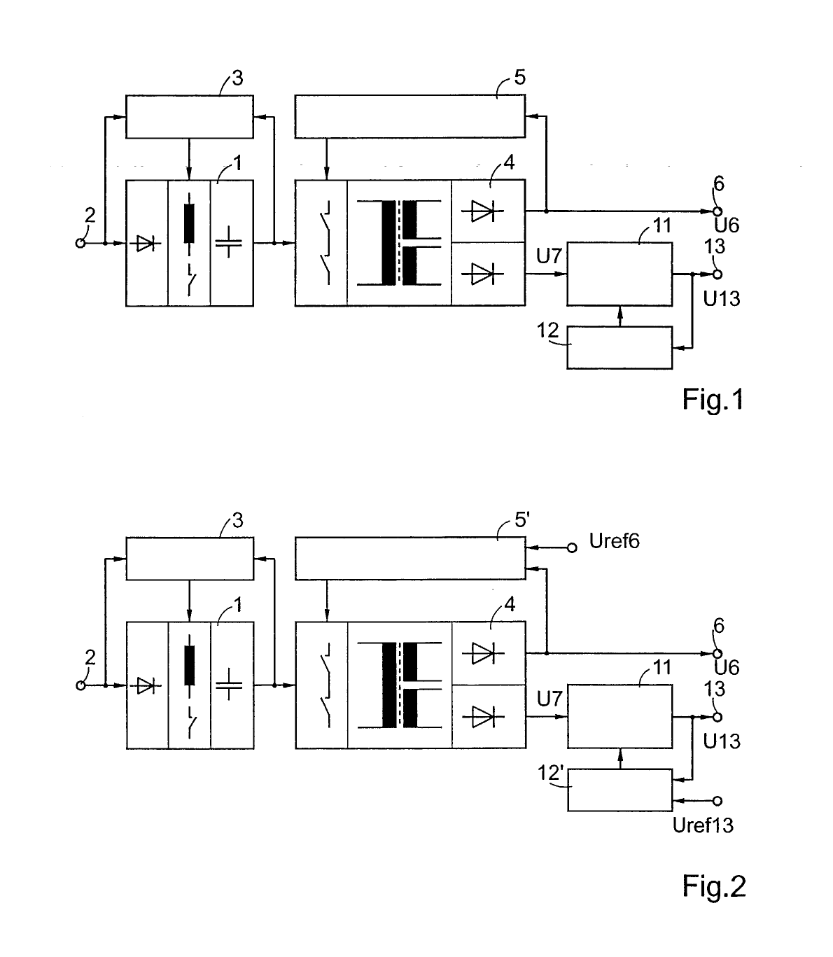

FIG. 1 shows a first example of embodiment,

FIG. 2 shows a second example of embodiment,

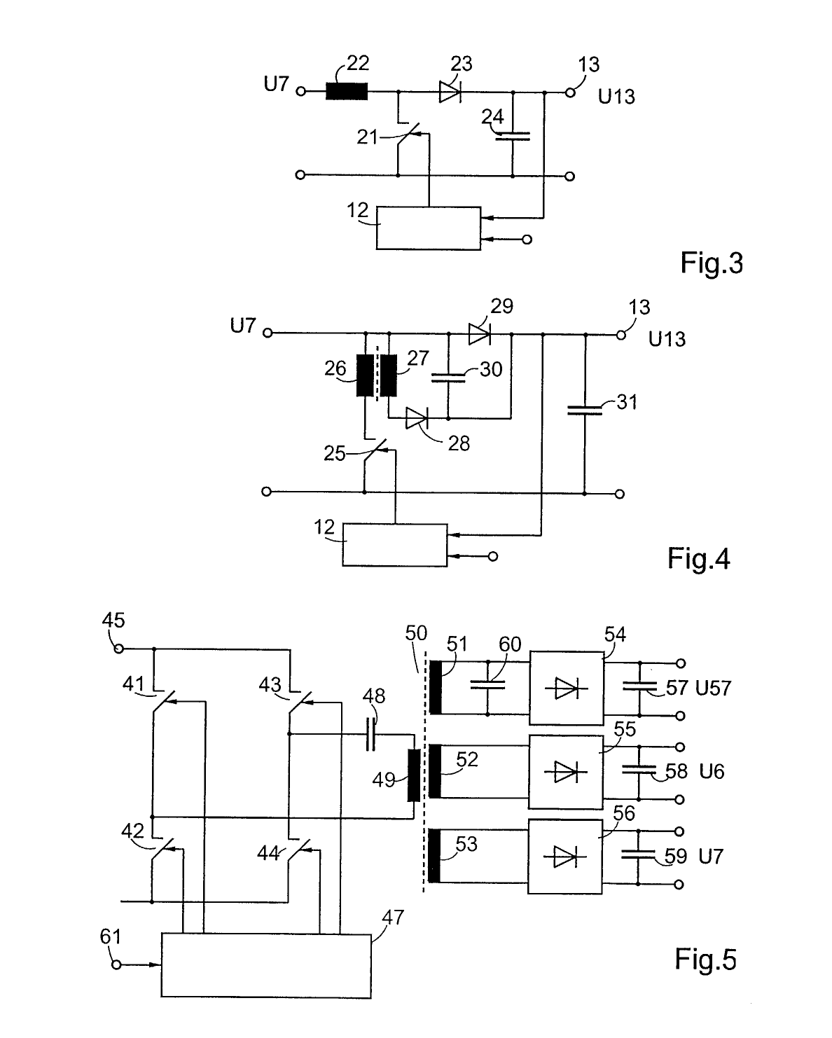

FIG. 3 shows an example of embodiment of a voltage actuator used in the power supply unit according to the invention,

FIG. 4 shows a circuit arrangement of a further voltage actuator, and

FIG. 5 shows an example of embodiment of a DC-DC voltage converter with a circuit for generating a standby operating voltage.

The example of embodiment shown in FIG. 1 is equipped with an active network filter 1 the input 2 of which can be connected to the network and from the output of which a regulated DC voltage Udc can be drawn. Active network filters of this kind are known per se and adequately described in the literature, e.g. in Hirschmann W.: “Schaltnetzteile: Konzepte, Bauelemente, Anwendungen”, Munich 1990, ISBN 3-8009-1550-2, pages 437 to 445. Active network filter 1 is therefore only briefly mentioned, wherein the supply voltage and the DC voltage Udc are fed to a regulator which controls the active network filter in the form of a constant DC voltage Udc.

Connected to the active network filter is a DC-DC voltage converter 4 which contains a transformer which provides for an electrical network isolation and is equipped on the secondary side with a number of windings. The secondary windings, fully isolated from each other, can thereby either serve to generate an output voltage or can be in the form of a so-called autotransformer winding. Connected to the secondary windings via a rectifier in each case are outputs 6, 7 and, if necessary, further outputs which are not shown. A regulator 5 regulates the voltage at output 6 to a constant value.

A voltage actuator 11 with a regulator 12 is series-connected to output 7. A regulated DC voltage U13 is therefore available at output 13. For the supply of plasma display panels, it is frequently not sufficient to make available constant voltages preset for all eventualities. On the contrary, supply voltages may differ from case to case. To this end, provision is made in the example of embodiment as shown in FIG. 2 for the capability of feeding an external reference voltage Uref6 and Uref13 to regulators 5′ and 12′ respectively. These voltages can be drawn from the plasma display panel.

Suitable as voltage actuators for voltage U7 and for any further regulated output voltages are the two examples of embodiment described below with reference to FIGS. 3 and 4. The unregulated input voltage U7, which is lower than voltage U13, is converted in the example of embodiment shown in FIG. 3 via a boost converter to the required output voltage level U13. The conversion ratio is set through variation of the duty cycle of a switch 21. To this end, regulator 12 compares voltage U13 with reference voltage Uref13. The required duty cycle with which switch 21 is actuated is determined from the difference. In other respects, the converter consists of a coil 22, a diode 23 and a capacitor 24. This converter must be sized for the maximum required output power.

Further circuits that are suitable as voltage actuators and must also be sized for the total power are full-bridge converters, half-bridge converters (hard-switching or soft-switching), buck converters, buck-boost converters and a forward converter or an arrangement with a controlled rectifier. The number of windings of the transformer can be selected to match the respective voltage transformation ratios of the voltage actuator.

In the example of embodiment of a voltage actuator shown in FIG. 4, a variable voltage is added to the input voltage U7. The input voltage of the voltage actuator is therefore selected such that it is always smaller than the required output voltage U13. The variable voltage is generated by means of an isolating transformer. The power converted in the isolating transformer derives from the product of the error voltage, from the output voltage and input voltage and the required load current. In comparison with the previous embodiment, therefore, a lower power output is to be set, so the required components can also be of smaller design. A switch 25 is actuated with the output voltage of regulator 12 and is series-connected to a primary winding 26 of a transformer. The voltage on its secondary winding 27 is rectified with the aid of diodes 28, 29, and smoothed with capacitor 30. The regulated voltage U13 is then available on a further capacitor 31 and thereby at output 13.

The DC-DC voltage converter shown in FIG. 5 comprises a bridge circuit of four semiconductor switches 41 to 44, which are actuated by a control circuit 47 in push-pull operation. The DC voltage generated by the active network filter 1 (FIGS. 1 and 2) is fed to terminals 45 and 46. Connected to the output of the bridge circuit is a series circuit comprising a capacitor 48 and the primary winding 49 of transformer 50. Transformer 50 is equipped with three secondary windings 51, 52, 53, to which respectively a rectifier 54, 55, 56 and a smoothing capacitor 57, 58, 59 are connected. Windings 52, 53 serve for generation of the already described operating voltages U6 and U7, whereas winding 51 is provided for generation of a voltage U57 for standby operation. A capacitor 60 is connected in parallel with winding 51. The resonant frequency thereby produced is above the resonant frequency of the series circuit of capacitor 58 and the leakage inductance of primary winding 49.

In normal operation of the connected plasma display panel, all voltages U6, U7 and U57 are generated. If the plasma display panel is to be switched off and maintained in standby operation, a suitable switching voltage is fed to an input 61, which results in a stepping-up of the switching frequency of the semiconductor switches 41 to 44. At this higher frequency, power is no longer transmitted via the secondary windings 52 and 53, whereas, owing to the resonance of capacitor 60 with the leakage inductance of secondary winding 51, voltage U57 is maintained and feeds, for example, a remote-control receiver.

A practically executed power supply unit is designed for automatic matching to supply voltages between 110 V and 230 V, wherein the DC voltage generated by the active network filter is approximately 400 V. U6 is then 175 V, while U7 is around 65 V.

1. A power supply unit for supplying power to a plasma display panel, wherein an active network filter (1) without electrical isolation is provided for the generation of an essentially constant DC voltage from an AC supply voltage, a DC-DC voltage converter (4) being connected to the output of the active network filter (1) with at least one first and one second output (6, 7) and with electrical isolation between the constant DC voltage and the outputs, a regulator (5, 5′) being assigned to the DC-DC voltage converter (4) to regulate the voltage at the first output (6), and a voltage actuator (11) being connected in series at least to the second output (7).

2. A power supply unit as claimed in claim 1, characterized in that the regulator (5′) regulates the voltage at the first output (6) to an applied first reference voltage.

3. A power supply unit as claimed in one of claims 1 or 2, characterized in that the voltage actuator (11) comprises a further regulator (12) to which a further reference voltage can be fed.

4. A power supply unit as claimed in one of the above claims, characterized in that the voltage actuator (11) sets the entire power drawn from this output.

5. A power supply unit as claimed in one of claims 1 to 3, characterized in that the voltage actuator (11) sets a power that is required for matching the voltage on the second output to the output voltage of the voltage actuator.

6. A power supply unit as claimed in one of the above claims, characterized in that the DC-DC voltage converter (4) is equipped with a transformer (50).

7. A power supply unit as claimed in claim 6, characterized in that the transformer (50) is equipped with an additional winding (51) which, together with a resonant capacitor (60), forms a resonant circuit with a resonant frequency higher than the operating frequency of the DC-DC voltage converter, in that the voltage at the resonant capacitor (60) can be drawn off via a rectifier (54) for supplying a standby operation, and in that a device (47, 61) is provided to increase the operating frequency to the resonant frequency of the resonant circuit (51, 60) when standby operation is to take place.
